(19) United States
(12) Patent Application Publication
(10) Pub. No.: US 2014/0020605 A1
(43) Pub. Date: Jan. 23, 2014

(54) Cantilevered Table

(71) Applicant: Mark R. Barie, Glenshaw, PA (US)

(72) Inventor: Mark R. Barie, Glenshaw, PA (US)

(21) Appl. No.: 13/857,187

(22) Filed: Apr. 5, 2013

Related U.S. Application Data
(60) Provisional application No. 61/620,576, filed on Apr. 5, 2012.

(51) Int. Cl. A47B 37/00; F16M 13/00

(52) U.S. Cl. CPC A47B 37/00; F16M 13/005
USPC 108/42; 248/354.6

(57) ABSTRACT

The invention is a cantilevered table removably clamped to the underside of the frame of a piece of furniture, such as a sofa, the table featuring a table top surface adjustably affixed to at least one curved vertical side member terminating at its bottom end in a foot that extends beyond the proximal edge of the top surface. At least one wedge or clamp assembly is affixed to a bottom end of one vertical side member, beyond the proximal edge of the table top surface, the wedge assembly adjustably expanded to close the gap between the floor surface and the underside of the furniture, causing the furniture to anchor the cantilevered table to the floor. A plurality of wedge adaptors are provided to accommodate varying furniture designs.

### CROSS REFERENCE TO RELATED APPLICATION

Reference is made to and priority claimed from U.S. provisional application Ser. No. 61/620,576, filed on Apr. 5, 2013.

### FIELD OF THE INVENTION

The present invention pertains to the field of furniture end tables. More particularly, the present invention pertains to tables for use with furniture such as sofas, chairs, and recliners.

### BACKGROUND OF THE INVENTION

The optimum living room is furnished with a mix of seating, tables, and lighting to create a comfortable socializing environment for approximately 5-8 adults. Ideally, a living room will have a standard (3 person) sofa, 2 chairs, and a loveseat (2 person sofa), with a coffee table in front of the sofa and with end tables placed at each arm rest of the sofa and loveseat, as well as beside each chair or recliner. Lamps are positioned on the end tables. In great rooms, in which multiple living spaces are combined into a single large room, often the living room—dining room, or living room—kitchen, an additional long narrow table is placed behind the sofa to partition the space.

As the living room is the most heavily used room in the house for socializing and relaxing, it also usually includes multiple entrances to allow access from several other rooms, and thus the furniture selection and arrangement must accommodate entrances and walkways to avoid awkward passage around the furniture. Traditional end tables, due to their height requirements, must be relatively heavy and of sufficient width for stability. If furniture placement requires an end table to be placed along a walkway or entrance, these traditional tables often protrude into the walking area, and thus present a tripping hazard. Many homeowners thus choose to eliminate end tables, but then are inconvenienced by the lack of a table upon which to place a beverage, the tv remote control, etc.

Some previous solutions have been to create small diameter tables to sit beside the sofa or chair arm rest, but the small footprint of these designs result in unstable tables that are easily bumped or knocked over, especially when placed alongside the walking paths through rooms, and are particularly unstable on carpeted surfaces. More stable designs, such as cantilevered tables that have relatively long feet extending underneath the table surface, as well as the ubiquitous folding “tv” table, with its X-brace legs, create potential tripping hazards for passersby. Other small tables gain stability by fitting over the arms of the sofa or chair, but these designs destroy the utility and visual lines of the furniture, since the arm rests of a sofa or chair are needed for seating comfort and a table occupying this important space trades comfort for convenience.

What is needed is a small, stable, and stylish end table to accommodate rooms with limited space, particularly along high traffic corridors and high visibility areas of the room.

### SUMMARY OF THE INVENTION

The invention is a cantilevered table designed to removably clamp to an underside of a frame for a piece of furniture, such as a sofa or chair, the table featuring a table top surface adjustably affixed to at least two curved vertical side members that at their top end are affixed to an underside of the table surface, and terminate at their bottom ends in feet extending beyond the edge of the table surface. In a preferred embodiment, at least two wedge assemblies in spaced apart relation are affixed to bottom ends of the vertical side members, beyond the edge of the table top surface, and adjust to span the gap between a floor surface and the underside of the furniture frame, the wedge assemblies anchoring the table to the furniture and to the floor. The wedge assemblies may include a plurality of adaptors to accommodate different gaps between the underside of varying furniture designs and the floor upon which it rests. A single wedge assembly may be substituted for the pair of wedge assemblies, and the table may be anchored exclusively to the furniture if the furniture is provided with two or more parallel frame members elevated off the floor surface.

### BRIEF DESCRIPTION OF THE DRAWINGS

The features and advantages of the invention will become apparent from a consideration of the subsequent detailed description presented in connection with accompanying drawings, in which:

FIG. 1a is a perspective view of the table according to the invention as it appears installed on a sofa.

FIG. 1b is a perspective view of the table according to the invention, as it would appear prior to installation.

FIG. 2 is an exploded view of the table according to the invention.

FIG. 3 is a side elevational view of the table, shown in position for installation but not clamped to an underside of a sofa, with the support leg of the sofa removed to allow visualization of the wedge assembly placement.

FIG. 4 is a side elevational view of the table in FIG. 3, shown with the wedge assembly clamped to the lateral support member of an underside of the sofa.

FIG. 5 is a perspective view of the bottom ends of the vertical side members and the wedge assemblies, with the upper wedge shown in an elevated (installed) position.

FIG. 6 is a perspective view of the installed table shown in FIG. 4, as viewed looking from under the sofa towards the table.

FIG. 7 is a perspective view of the installed table shown in FIG. 4, as viewed looking from the front face of the lower brace of the table towards the underside of the sofa.

FIG. 8a is a perspective view of the table according to the invention, shown as viewed from behind the sofa.

FIG. 8b is a perspective view of another embodiment of the table, as installed on the back of a sofa.

### DRAWINGS LIST OF REFERENCE NUMERALS

The following is a list of reference labels used in the drawings to label components of different embodiments of the invention, and the names of the indicated components.
10 cantilevered table
20 table top
20a underside of table top
20c outer edge of table top
20d inner edge of table top
22 top support
22a distal edge of top support
22b proximal edge of top support
22c through holes
30 upper brace
32 lower brace
32a front face of lower brace
34 vertical side member
34a top end of vertical side member
34b bottom end of vertical side member
40 base
42 lateral edge of base
44 distal edge of base
46 proximal edge of base
50 clamp or wedge assembly
52 upper wedge
54 lower wedge
55 aperture
56 wedge adjustment bolt
58 wing-nut
60 fasteners
70 floor surface
80 sofa
82 arm rest of sofa
84 lateral support of sofa frame
86 back support of sofa frame
88 sofa leg

### DETAILED DESCRIPTION

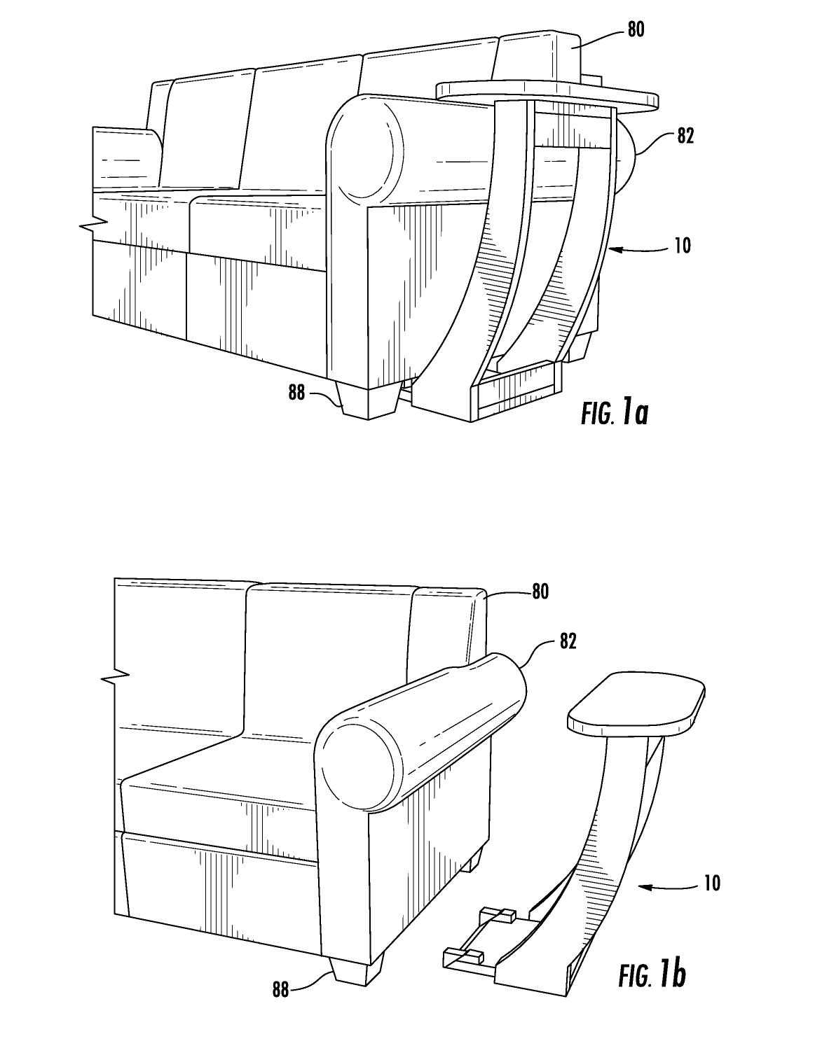

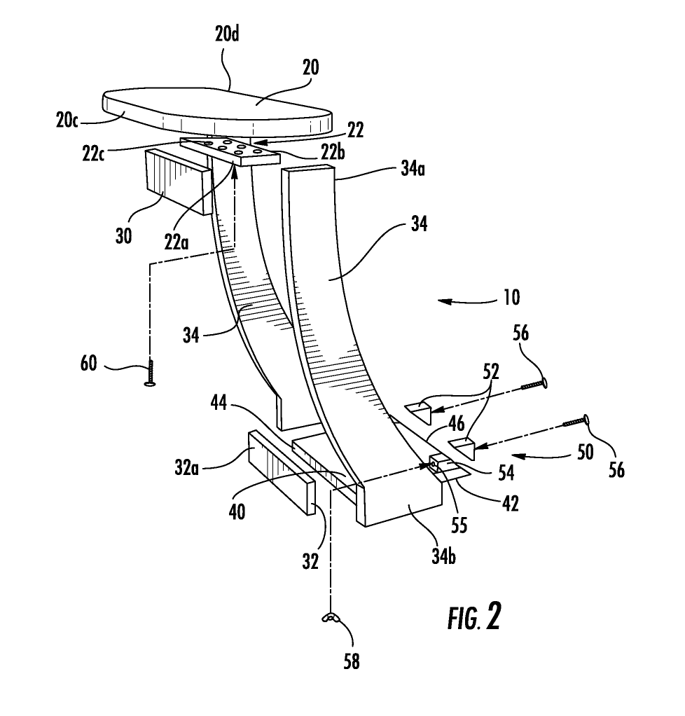

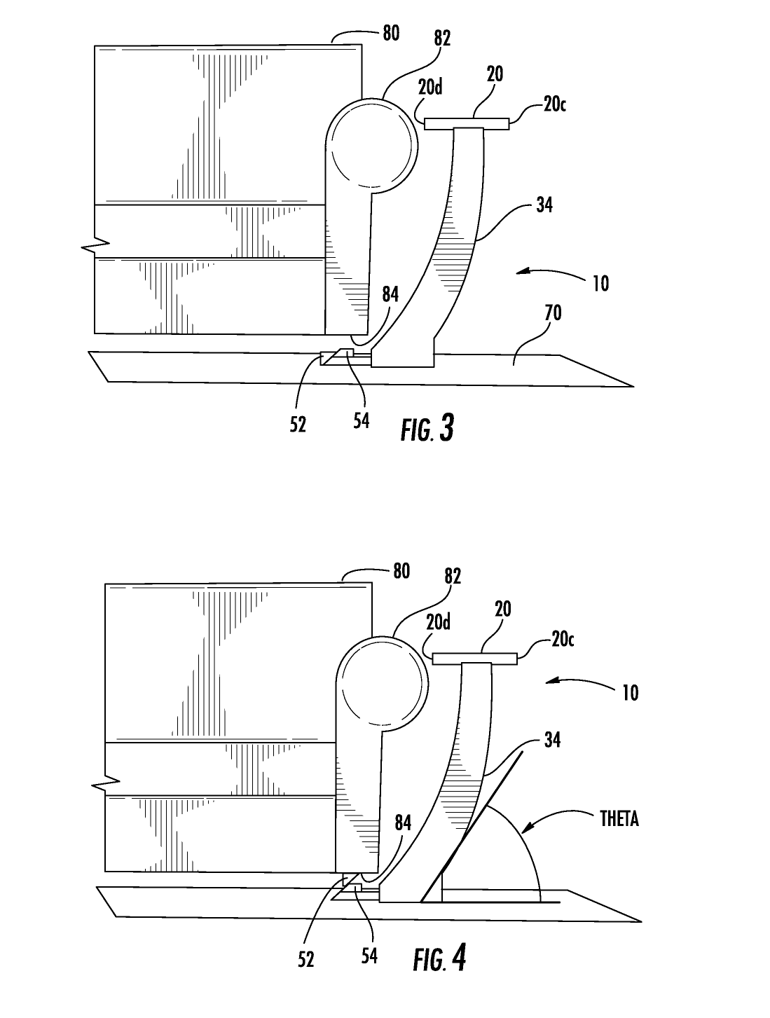

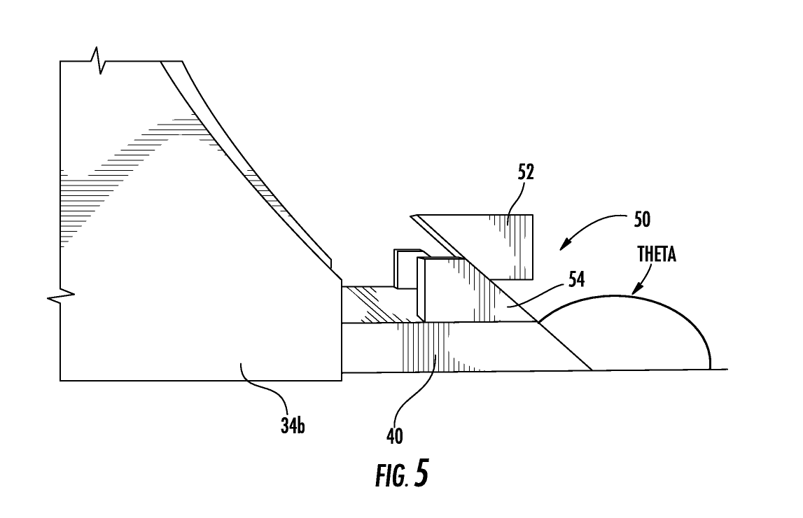

A first embodiment of a cantilevered table 10 according to the invention is shown in FIGS. 1-8b. Looking at FIG. 2, begin assembly by using three fasteners 60, typically 1¼″ wood screws, to securely fasten a bottom end 34b of each vertical side member 34 to a lateral edge 42 of a base 40, such that the base 40 is affixed between the vertical side members 34. Attach a top support 22 to a top end 34a of the vertical side members 34 using four fasteners 60, positioning the top support 22 parallel to the base 40. Due to the curve in the vertical side members 34, the top end 34a and the affixed top support 34 will extend beyond a distal end 44 of the base 40. Looking more specifically at FIG. 4, the angle at which the bottom ends 34b of the vertical side members 34 curve away from the top ends 34a is shown as angle theta, which in the present embodiment is about 60 degrees. The value of theta can range anywhere between 20 and 90 degrees, but the inventor has found that at 60 degrees, as shown in the Figures, the base is tucked well out of the walking area around the table. A lower brace 32 is affixed to the distal edge 44 of the base 40 using four fasteners 60, and fits between the vertical side members 34. An upper brace 30 is affixed to a distal edge 22a of the top support 22.

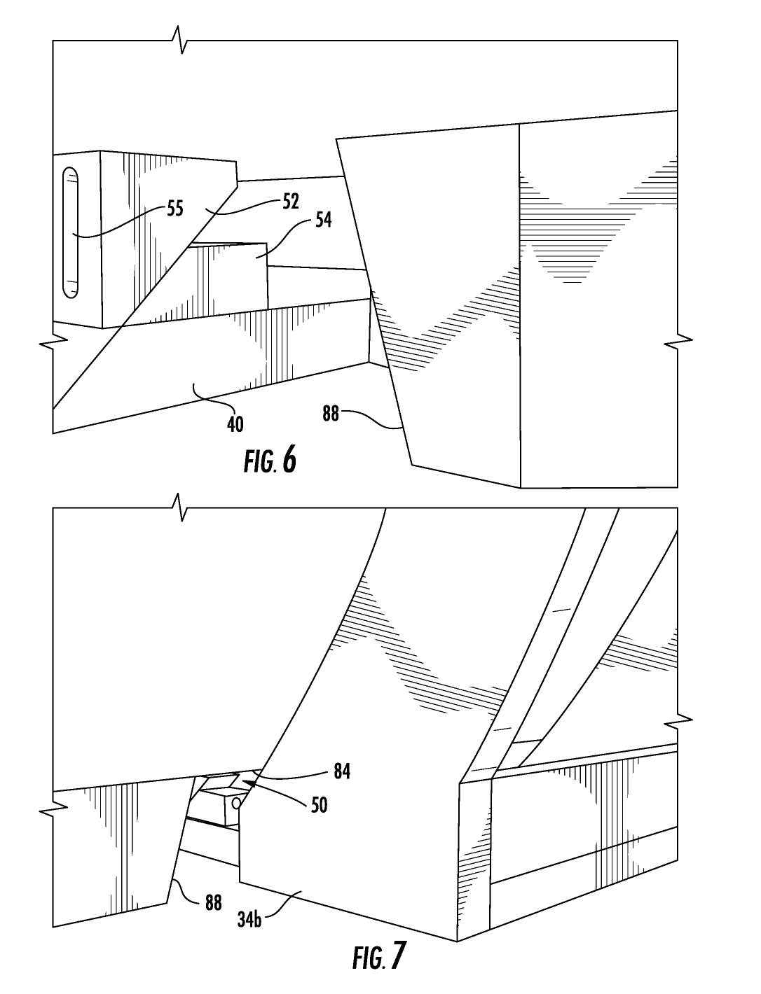

Each clamp or wedge assembly 50 is assembled by positioning an upper wedge 52 over a lower wedge 54, such that the pair of wedges 52 54 form a rectangle or a square, and a single wedge adjustment bolt 56 is inserted first through an elongated through-aperture 55 (FIG. 6) in the upper wedge 52, and then into a second through-aperture (shown in FIG. 7) in the lower wedge 54. The end of the adjustment bolt 56 will protrude out of the through-aperture formed in the lower wedge 54. A wing-nut 58 and a washer (not shown) are threaded onto the protruding adjustment bolt 56. Each wedge assembly 50 is affixed to the base 40 near a proximal edge 46 using a small amount of wood glue, if desired. It should be noted that the wedge assemblies 50 are still functional even if not affixed to the base 40, however they must be located at or near the proximal edge 46 of the base 40. A table top 20 is provided with a plurality of holes (not shown) in a predetermined arrangement on an underside 20a of the table top 20, the holes sized and oriented so as to correspond with the pattern and size of through-holes 22c in the top support 22. Fasteners 60 are inserted into at least two of the through-holes 22c and the holes to secure the table top 20 to the top support 22. The pattern of holes allow the table top 20 to be adjusted towards or further away from an arm rest 82 of a sofa 80 to accommodate varying shaped arm rests of different sofas.

In a second embodiment, not shown, the table 10 according to the invention may be provided without the base 40, and instead, the wedge assemblies 50 may be directly affixed to the bottom ends 34b of the vertical side members 34, and for aesthetics, to a medial side of the vertical side members 34 such that they are not visible when viewing the table in its installed position adjacent to a sofa arm rest 82.

To install the table according to the invention next to an arm rest of a sofa, the base 40 and/or the bottom ends 34b of each vertical side member 34 is placed on a floor surface 70 and slid under a desired side of the sofa 80 until each wedge assembly 50 is under a lateral support member 84 of the sofa 80. Once positioned, the wedge adjustment bolt 56 is tightened by turning the wing-nut 58, causing the upper wedge 52 to slide upwards and against the lateral support member 84 of the sofa 80 to close the gap between the lateral support member 84 and the floor surface 70 so as to provide a secure fit. The upper wedge 52 slides up or down on the adjustment bolt 56 via the elongated slot 55. Tightening the wing nut 58 causes the upper wedge to slide upwards, loosening it causes the upper wedge to slide downwards. It should be noted that so long as the wedge assembly 50 closes the gap between the lateral support member 84 and either the base 40 or in the second embodiment of the invention, the floor surface 70, the table 10 is secure and upright. The Figures show a pair of wedge assemblies 50, however, a single wedge assembly 50 of sufficient size, either affixed to the base 40 or to the bottom end 34b of at least one vertical side member 34, is also capable of anchoring the table to the furniture, thus the single wedge assembly 50 could be substituted for the pair of assemblies 50 shown in the Figures. The table top 20 is then adjusted until a desired location adjacent the arm rest 82 is determined. The table 10 is cantilevered and held in place by the wedge assembly or assemblies 50 against the floor surface 70 and the lateral support member 84. The bottom ends 34b of the vertical side members 34 curve toward the sofa 80 and thus create an open space beneath the table top 20, eliminating supports that might otherwise protrude into walking areas. The cantilever design thus results in a small, stable table that maximizes utility of the table top 20 and minimizes tripping hazards below the table top surface on the floor surface 70 and the immediate vicinity around the table.

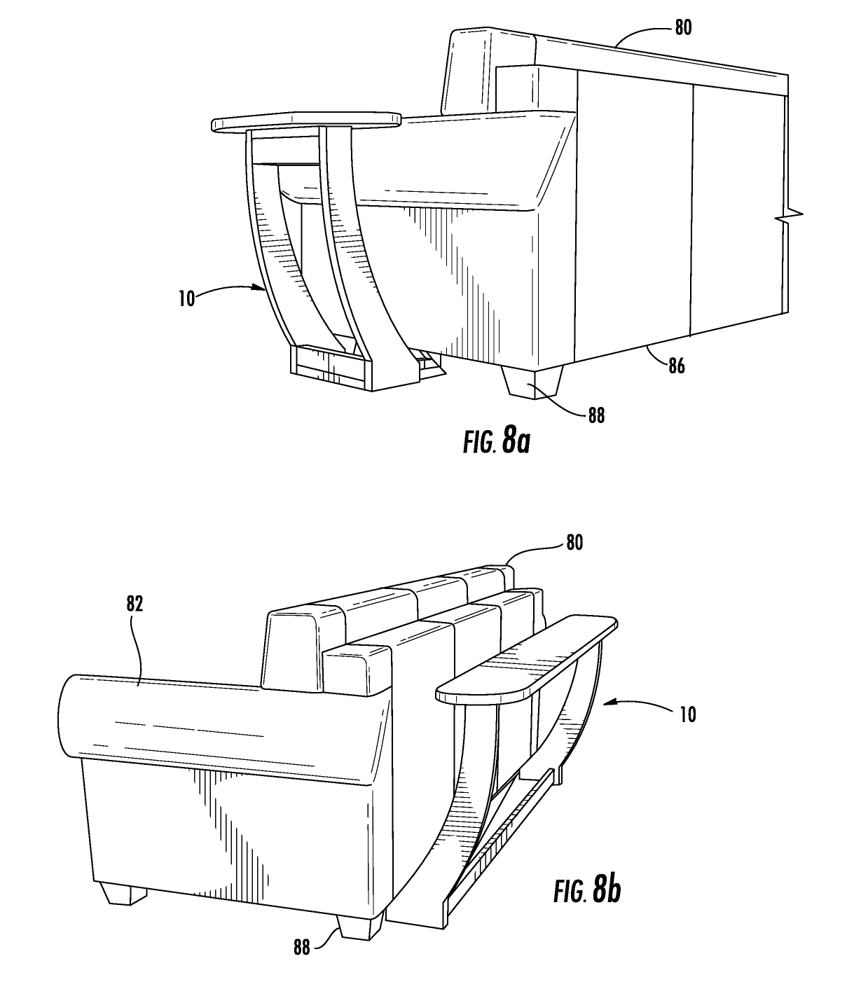

In a third embodiment shown in FIG. 8b, the table 10 according to the invention provides a narrow, elongated table top 20 installed along a back side of the sofa 80, the wedge assemblies 50 fitted against a back support member 86 (shown in FIG. 8a) of an underside of the sofa 80.

The table 10 according to the invention, unlike the prior art cantilevered tables, is not self supporting, and requires the wedge assemblies 50 to be secured between the floor surface 70 and the lateral 84 or back support member 86 of the underside of the sofa 80. The sofa 80 anchors the table 10 to the floor surface 70, and given the weight of a typical sofa compared to the table 10, the sofa will most often weigh enough to effectively balance the table top 20 (and things placed upon it, such as plates of food) and render the table secure and stable.

Paint and/or stain grade wood is suitable for construction of the table as described in the embodiments within, however, a mix of different materials, such as metal, plastic, stone, and other traditional materials are also suitable. Heavier materials, such as stone, are only recommended if the table will be clamped to a relatively heavy piece of furniture. The table top 20 in some embodiments (not shown) may also include a raised lip or border along the perimeter of the outer edge 20c of the table top 20 opposite the side directly adjacent to the sofa arm rest 82, to further guard against items inadvertently rolling or sliding off the table top 20 as might be the case if the table is bumped by someone walking past it. Installed correctly, with the wedge assemblies 50 firmly in position, the table top 20 is level and stable and will not be dislodged by normal use.

While the embodiments thus described and shown in the Figures depict the use of the table 10 with the sofa 80, it should be noted that the table 10 is also suitable for chairs, stationary base (non-rocking) recliners, and other types of furniture and the Figures should not be interpreted as limiting the table 10 to sofas or even to upholstered furniture in general. Depending on design, different sofas, chairs, etc. may have different sized gaps between the underside of the back or lateral supports of the furniture frame and the floor surface, hence, the table 10 includes adaptor pieces (not shown) placed on the upper wedge 52 of the wedge assembly 50 to help close the gap. The adaptor pieces are shaped to complement the furniture to which it will be clamped, for instance, they may have planar surfaces, or may include a channel in the event the underside of the furniture is nonplanar, such as the lateral supports typically found on many dining room chairs. Additionally, the table 10 according to the invention may also be clamped directly to a piece of furniture and not to the floor surface 70 in the event the furniture is provided with multiple lateral or back support members that are elevated above the floor surface, such as in the case of a typical dining room chair which features a lateral support member in addition to the lateral support that directly supports the chair seat. With such designs, the table 10 may be clamped to chair by adjusting the upper wedge 52 against the underside of the chair seat and the lower wedge 54 against the lateral support. While not shown in the Figures, it should also be noted that a relatively small table top may be sufficiently supported by a single vertical member, and larger or heavy table tops may be supported by two or more vertical members.

It is to be understood that the arrangements shown and described above and in the attachments are only illustrative of the application of the principles of the present invention. The cantilevered table according to the invention may be clamped to other types of furniture, such as bed frames, as well as to other structures that feature protrusions sufficient for clamping by the wedge assembly, including exterior walls. Numerous modifications and alternative arrangements may be devised by those skilled in the art without departing from the scope of the present invention, and the appended claims are intended to cover such modifications and arrangements.

What is claimed is:

1. A cantilevered table for use with a piece of furniture, the table comprising:
a table top surface having an underside and a topside, and further comprising an inner edge;
a top support affixed to the underside of the table top surface;
at least one vertical side member having a top end affixed to the top support, and a bottom end affixed to an adjustable wedge assembly;
wherein the bottom end of the at least one vertical side member and the wedge assembly extend beyond the inner edge of the table top surface,
whereby the table is positioned adjacent to a side or back of the piece of furniture so that the wedge assembly sits on a floor surface and is positioned beneath a back or lateral support member of the piece of furniture, and the table is positioned upright by adjusting the wedge assembly to span the gap between the floor surface and the back or lateral support member so as to simultaneously anchor the table to the floor surface and to the furniture.

2. The table in claim 1, further comprising a base affixed to the bottom end of the at least one vertical side member, the base further comprising a proximal edge, and wherein the wedge assembly is affixed to the base at the proximal edge of the base.

3. The base of claim 2, further comprising at least one foot on the underside of the base.

4. The wedge assembly in claim 1, each assembly further comprising an upper wedge and a lower wedge, the upper wedge provided with an slotted through-aperture, and the lower wedge provided with a through-aperture, the wedges fitted together to substantially form a rectangle, a wedge adjustment bolt inserted into the upper wedge aperture and then into the lower wedge aperture and secured with a wing-nut, whereby the assembly is adjusted by turning the wing-nut, causing the upper wedge to slide along the lower wedge via the slotted through-aperture.

5. The wedge assembly of claim 1, further comprising an adaptor member, wherein the adaptor member is removably affixed to the wedge assembly.

6. The table of claim 1, wherein the piece of furniture is a sofa.

7. The table of claim 1, wherein the piece of furniture is a chair.

8. The clamp assembly of claim 1, comprising a pair of wedge assemblies in spaced apart relation.

9. The table of claim 1, wherein the top end of the vertical side member curves away from the bottom end of the vertical side member by about 60 degrees from the horizontal.

10. The table of claim 1, wherein the wedge assembly anchors the table to two parallel support members of the furniture, whereby the table is secured solely to the piece of furniture and not also to the floor surface.
